(19) United States
(12) Patent Application Publication
(10) Pub. No.: US 2022/0245933 A1
(43) Pub. Date: Aug. 4, 2022

(54) METHOD FOR NEURAL NETWORK TRAINING, METHOD FOR IMAGE SEGMENTATION, ELECTRONIC DEVICE AND STORAGE MEDIUM

(71) Applicant: SHANGHAI SENSETIME INTELLIGENT TECHNOLOGY CO, LTD., Shanghai (CN)

(72) Inventors: Liang ZHAO, Shanghai (CN); Chang LIU, Shanghai (CN); Shuaining XIE, Shanghai (CN)

(21) Appl. No.: 17/723,587

(22) Filed: Apr. 19, 2022

Related U.S. Application Data
(63) Continuation of application No. PCT/CN2020/100729, filed on Jul. 7, 2020.

(30) Foreign Application Priority Data
Oct. 31, 2019 (CN) 201911063105.0

(51) Int. Cl. G06V 10/82; G06V 10/40; G06V 10/80; G06V 10/764; G06T 7/10; G06N 3/08

(52) U.S. Cl. CPC G06V 10/82; G06V 10/40; G06V 10/806; G06V 10/764; G06T 2207/20081; G06N 3/08; G06T 2207/10088; G06T 2207/30008; G06T 2207/20084; G06T 7/10

(57) ABSTRACT

A method for neural network training, a method for image segmentation, an electronic device and a computer storage medium are provided. The method for neural network training includes: extracting, through a first neural network, a first feature of a first image and a second feature of a second image; fusing, through the first neural network, the first feature and the second feature to obtain a third feature; determining, through the first neural network, a first classification result of overlapped pixels in the first image and the second image according to the third feature; and training the first neural network according to the first classification result and labeled data corresponding to the overlapped pixels.

### CROSS-REFERENCE TO RELATED APPLICATION

The disclosure is a continuation of International Patent Application No. PCT/CN2020/100729, filed on Jul. 7, 2020, which is based upon and claims priority to Chinese Patent Application No. 201911063105.0, filed on Oct. 31, 2019. The contents of International Patent Application No. PCT/CN2020/100729 and Chinese Patent Application No. 201911063105.0 are hereby incorporated by reference in their entireties.

### BACKGROUND

Image segmentation is a technique and process to divide an image into a number of specific regions with unique properties and propose a target of interest. The image segmentation is a key step from image processing to image analysis. How to improve the accuracy of image segmentation is an urgent problem to be solved.

### SUMMARY

Embodiments of the disclosure relates to the field of computer technologies and provide a method for neural network training, a method for image segmentation, an electronic device, and a non-transitory computer-readable storage medium.

In a first aspect, the embodiments of the disclosure provide a method for neural network training, comprising:

extracting a first feature of a first image and a second feature of a second image through a first neural network;

fusing the first feature and the second feature through the first neural network to obtain a third feature;

determining a first classification result of overlapped pixels in the first image and the second image according to the third feature through the first neural network;

training the first neural network according to the first classification result and labeled data corresponding to the overlapped pixels.

In a second aspect, the embodiments of the disclosure provide a method for neural network training, comprising:

determining a third classification result of overlapped pixels in a first image and a second image through a first neural network;

determining a fourth classification result of pixels in the first image through a second neural network;

training the second neural network according to the third classification result and the fourth classification result.

In a third aspect, the embodiments of the disclosure provide a method for image segmentation, comprising:

obtaining the trained second neural network according to the method for neural network training;

inputting a third image into the trained second neural network and outputting a fifth classification result of pixels in the third image through the trained second neural network.

In a fourth aspect, the embodiments of the disclosure provide an electronic device, comprising:

one or more processors and a memory configured to store an executable instruction. The one or more processors are configured to call the executable instruction stored in the memory to performing the following operations comprising:

extracting a first feature of a first image and a second feature of a second image through a first neural network;

fusing the first feature and the second feature through the first neural network to obtain a third feature;

determining a first classification result of overlapped pixels in the first image and the second image through the first neural network according to the third feature; and

training the first neural network according to the first classification result and labeled data corresponding to the overlapped pixels.

In a fifth aspect, the embodiments of the disclosure provide a non-transitory computer-readable storage medium having stored thereon a computer program instruction that, when executed by a processor of an electronic device, causes the processor to perform the method for neural network training.

It is to be understood that the above general descriptions and detailed descriptions below are only exemplary and explanatory and not intended to limit the disclosure.

### BRIEF DESCRIPTION OF THE DRAWINGS

The accompanying drawings, which are incorporated in and constitute a part of this specification, illustrate embodiments consistent with the disclosure and, together with the specification, serve to illustrate the technical solutions of the embodiments of the disclosure.

FIG. 1 is a flowchart of a method for neural network training provided by an embodiment of the disclosure.

FIG. 2 is a diagram of a first neural network in a method for neural network training provided by an embodiment of the disclosure.

FIG. 3A is a diagram of a pelvic bone tumor region in a method for image segmentation provided by an embodiment of the disclosure.

FIG. 3B is a diagram of an application scenario in an embodiment of the disclosure.

FIG. 3C is a diagram of a processing flow for pelvic bone tumor in the embodiments of the disclosure.

FIG. 4 is a structure diagram of a device for neural network training provided by an embodiment of the disclosure.

FIG. 5 is a structure diagram of an electronic device provided by an embodiment of the disclosure.

FIG. 6 is a structure diagram of another electronic device provided by an embodiment of the disclosure.

### DETAILED DESCRIPTION

Each exemplary embodiment, feature and aspect of the disclosure will be described below with reference to the drawings in detail. The same reference signs in the drawings represent components with the same or similar functions. Although each aspect of the embodiments is shown in the drawings, the drawings are not required to be drawn to scale, unless otherwise specified.

The special word “exemplary” here means “as an example, embodiment or illustration”. Here, it is unnecessary to interpret any embodiment described as “exemplary” as being better than other embodiments.

In the disclosure, term “and/or” is only an association relationship describing associated objects and represents that three relationships can exist. For example, A and/or B can represent three conditions: i.e., independent existence of A, existence of both A and B and independent existence of B. In addition, term “at least one” in the disclosure represents any one of multiple or any combination of at least two of multiple. For example, including at least one of A, B or C can represent including any one or more elements selected from a set formed by A, B and C.

In addition, for describing the disclosure better, many specific details are presented in the following specific implementation modes. It is understood by those skilled in the art that the disclosure can still be implemented even without some specific details. In some embodiments, methods, means, components and circuits known very well to those skilled in the art are not described in detail, to highlight the subject of the disclosure.

In the related art, malignant bone tumor is a disease with high mortality rate. At present, one of the mainstream clinical treatment methods for malignant bone tumor is limb salvage surgery. Due to the complex structure of the pelvis and the pelvis contains many other tissues and organs, it is extremely difficult to perform the limb salvage surgery for the bone tumor located in the pelvis. The recurrence rate and postoperative recovery effect of the limb salvage surgery are affected by the resection boundary, so the determination of bone tumor boundary in an MRI image is an extremely important and critical step in preoperative surgical planning. However, it takes a long time and requires rich experience for doctors to draw the tumor boundary manually, which largely restricts the promotion of the limb salvage surgery.

For the above technical problem, the embodiments of the disclosure provide a method, device, electronic equipment, computer storage medium and computer program for neural network training and image segmentation.

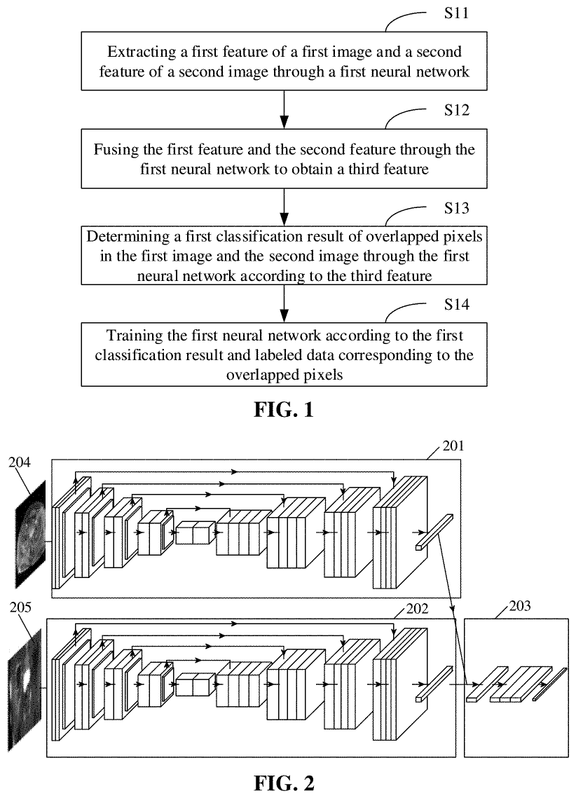

FIG. 1 is a flowchart of a method for neural network training provided by an embodiment of the disclosure. The performing entity of the method for neural network training is a device for neural network training. For example, the device for neural network training is a terminal device or a server or other processing devices. The terminal device is User Equipment (UE), a mobile device, a user terminal, a terminal, a cell phone, a cordless phone, a Personal Digital Assistant (PDA), a handheld device, a computing device, a vehicle device, a wearable device, or the like. In some embodiments of the disclosure, the method for neural network training is implemented by a processor through calling a computer-readable instruction stored in a memory.

In some embodiments of the disclosure, a first neural network and a second neural network is used to automatically segment tumor regions in an image, that is, the first neural network and the second neural network are used to determine the region where the tumor is in the image. In some embodiments of the disclosure, the first neural network and the second neural network is also used to segment other regions of interest in the image automatically.

In some embodiments of the disclosure, the first neural network and the second neural network are used for automatically segmenting bone tumor regions in an image, that is, the first neural network and the second neural network are used for determining the region where the bone tumor is in the image. In an example, the first neural network and the second neural network are used for automatically segmenting bone tumor regions in the pelvis. In other examples, the first neural network and the second neural network are also used for automatically segmenting bone tumor regions in other parts.

As shown in FIG. 1, the method for neural network training includes S11 to S14, comprising:

S11: extracting a first feature of a first image and a second feature of a second image through a first neural network.

In the embodiments of the disclosure, the first image and the second image are scanned images of the same object. For example, the object is a human body. For example, the first image and the second image are obtained by the same machine through continuous scanning, and the object is barely moving during scanning.

In some embodiments of the disclosure, each of the first image and the second image is a scanned image, and a scanning plane of the first image is different from a scanning plane of the second image.

In the embodiments of the disclosure, the scanning plane is a transverse plane, a coronal plane, or a sagittal plane. The image whose scanning plane is a transverse plane is called a transverse image, the image whose scanning plane is a coronal plane is called a coronal image, and the image whose scanning plane is a sagittal plane is called a sagittal image.

In other examples, the scanning planes of the first image and the second image are not limited to the transverse plane, the coronal plane and the sagittal plane, as long as the scanning plane of the first image is different from the scanning plane of the second image.

It can be seen that in the embodiments of the disclosure, the first image and the second image obtained by scanning with different scanning planes are adopted to train the first neural network, so three-dimensional space information in the image is fully utilized and the problem of low inter-layer resolution of the image is overcome to a certain extent, which is helpful for more accurate image segmentation in the three-dimensional space.

In some embodiments of the disclosure, each of the first image and the second image is a three-dimensional image obtained by scanning layer by layer. Each layer is a two-dimensional slice.

In some embodiments of the disclosure, each of the first image and the second image is an MRI image.

It can be seen that using MRI image can reflect tissue structure information (e.g., anatomical details, tissue density, and/or tumor location) of an object.

In some embodiments of the disclosure, each of the first image and the second image is a three-dimensional MRI image. The three-dimensional MRI image is scanned layer by layer and is regarded as a stack of a series of two-dimensional slices. The resolution of the three-dimensional MRI image on the scanning plane is generally higher, which is called in-plane spacing. The resolution of the three-dimensional MRI image in a stacking direction is generally low, which is called inter-plane spacing or slice thickness.

S12: fusing the first feature and the second feature through the first neural network to obtain a third feature.

In some embodiments of the disclosure, fusing the first feature and the second feature through the first neural network includes that: making connection processing on the first feature and the second feature through the first neural network. For example, the connection processing is concat-processing.

S13: determining a first classification result of overlapped pixels in the first image and the second image through the first neural network according to the third feature.

In some embodiments of the disclosure, the overlapped pixels in the first image and the second image are determined according to the coordinates of the pixels of the first image and the pixels of the second image in the world coordinate system.

In some embodiments of the disclosure, the classification result includes one or two of: a probability that the pixel belongs to the tumor region, or a probability that the pixel belongs to the non-tumor region. The tumor boundary in the image is determined according to the classification result. Here, the classification result is one or more of: the first classification result, the second classification result, the third classification result, the fourth classification result and the fifth classification result in the embodiments of the disclosure.

In some embodiments of the disclosure, the classification result includes one or two of: a probability that the pixel belongs to the bone tumor region, or, a probability that the pixel belongs to the non-bone tumor region. The bone tumor boundary in the image is determined according to the classification result. Here, the classification result is one or more of: the first classification result, the second classification result, the third classification result, the fourth classification result and the fifth classification result in the embodiments of the disclosure.

FIG. 2 is a diagram of a first neural network in the method for neural network training provided by an embodiment of the disclosure. As shown in FIG. 2, the first neural network includes a first sub-network 201, a second sub-network 202 and a third sub-network 203. The first sub-network 201 is configured to extract the first feature of the first image 204, the second sub-network 202 is configured to extract the second feature of the second image 205, and the third sub-network 203 is configured to fuse the first feature and the second feature to obtain the third feature, and determine, according to the third feature, the first classification result of the overlapped pixels in the first image 204 and the second image 205.

In some embodiments of the disclosure, it can be seen that the feature of the first image and the feature of the second image are extracted respectively, and the classification results of the overlapped pixels in the first image and the second image are determined by combining the features of the first image and the second image, so as to achieve more accurate image segmentation.

In the embodiments of the disclosure, the first neural network is a dual model dual path pseudo 3-dimension neural network. The scanning plane of the first image 204 is different from the scanning plane of the second image 205, so the first neural network makes full use of the images of different scanning planes to achieve the accurate segmentation of pelvic bone tumor.

In the embodiments of the disclosure, the first sub-network 201 is an end-to-end encoder-decoder structure.

In some embodiments of the disclosure, the first sub-network 201 is a U-Net without the last two layers.

It can be seen that by adopting the U-Net without the last two layers as the structure of the first sub-network 201, the first sub-network 201 makes use of the features of different scales of the image when extracting the features of the image, and fuses the features extracted from the first sub-network 201 at a relatively shallow layer with the features extracted from the first sub-network 201 at a relatively deep layer, so as to fully integrate and make use of multi-scale information.

In the embodiments of the disclosure, the second sub-network 202 is an end-to-end encoder-decoder structure.

In some embodiments of the disclosure, the second sub-network 202 is a U-Net without the last two layers.

In the embodiments of the disclosure, by adopting the U-Net without the last two layers as the structure of the second sub-network 202, the second sub-network 202 makes use of the features of different scales of the image when extracting the features of the image, and fuses the features extracted from the second sub-network 202 at a relatively shallow layer with the features extracted from the second sub-network 202 at a relatively deep layer, so as to fully integrate and make use of multi-scale information.

In some embodiments of the disclosure, the third sub-network 203 is a multilayer perceptron.

In the embodiments of the disclosure, by adopting the multilayer perceptron as the structure of the third sub-network 203, it is helpful to further improve the performance of the first neural network.

Referring to FIG. 2, each of the first sub-network 201 and the second sub-network 202 is the U-Net without the last two layers. An illustration is given below taking the first sub-network 201 as an example. The first sub-network 201 includes an encoder and a decoder. The encoder is used for encoding and processing the first image 204, and the decoder is used for decoding and repairing image details and spatial dimensions, thereby extracting the first feature of the first image 204.

The encoder includes multiple encoding blocks, and each of the encoding blocks includes: multiple convolution layers, a Batch Normalization (BN) layer, and an activation layer. The input data is subsampled through each encoding block to halve the size of the input data. The input data of the first encoding block is the first image 204, and the input data of other encoding blocks is a feature map output by the previous encoding block. The numbers of channels corresponding to the first encoding block, the second encoding block, the third encoding block, the fourth encoding block, and the fifth encoding block are 64, 128, 256, 512 and 1024, respectively.

The decoder includes multiple decoding blocks, and each of the decoding blocks includes: multiple convolution layers, a BN layer, and an activation layer. The input feature map is up-sampled through each decoding block to double the size of the feature map. The numbers of channels corresponding to the first decoding block, the second decoding block, the third decoding block and the fourth decoding block are 512, 256, 128 and 64, respectively.

In the first sub-network 201, a network structure with jump connection is used to connect the encoding block and the decoding block which have the same number of channels. In the last decoding block (the fifth decoding block), a 1×1 convolution layer is used to map the feature map output through the fourth decoding block to the one-dimensional space to obtain a feature vector.

In the third sub-network 203, the first feature output by the first sub-network 201 is fused with the second feature output through the second sub-network 202 to obtain the third feature. Then, the first classification result of the overlapped pixels in the first image 204 and the second image 205 is determined through the multilayer perceptron.

S14: training the first neural network according to the first classification result and labeled data corresponding to the overlapped pixels.

In the embodiments of the disclosure, the labeled data is artificially labeled data, for example, the labeled data is the data labeled by doctors. The doctors label data layer by layer on the two-dimensional slices of the first image and the second image. According to a labeled result of the two-dimensional slice of each layer, three-dimensional labeled data is integrated.

In some embodiments of the disclosure, the difference between the first classification result and the labeled data corresponding to the overlapped pixels is determined by using the Dice similarity coefficient, thereby training the first neural network according to the difference. For example, parameters of the first neural network are updated by back propagation.

In some embodiments of the disclosure, the method further includes: determining a second classification result of pixels in the first image through a second neural network; and training the second neural network according to the second classification result and the labeled data corresponding to the first image.

In the embodiments of the disclosure, the first image is a three-dimensional image, and the second neural network is used for determining the second classification results of the pixels of the two-dimensional slices of the first image. For example, the second neural network is used for determining the second classification result of each pixel of each two-dimensional slice of the first image layer by layer. The second neural network is trained according to the difference between the second classification result of the pixels of the two-dimensional slice of the first image and the labeled data corresponding to the two-dimensional slice of the first image. For example, parameters of the second neural network are updated by back propagation. The difference between the second classification result of the pixels of the two-dimensional slice of the first image and the labeled data corresponding to the two-dimensional slice of the first image is determined by using the Dice similarity coefficient, which is not limited by the implementation mode.

It can be seen that in the embodiments of the disclosure, the second neural network is used to determine segmentation results of the image layer by layer, which overcomes the problem of low inter-layer resolution of the image and obtains more accurate segmentation results.

In some embodiments of the disclosure, the method further comprises: determining a third classification result of the overlapped pixels in the first image and the second image through the trained first neural network; determining a fourth classification result of the pixels in the first image through the trained second neural network; and training the second neural network according to the third classification result and the fourth classification result.

It can be seen that in the embodiments of the disclosure, the second neural network is trained under the supervision of the classification result of the overlapped pixels which is output by the trained first neural network, which further improves the segmentation accuracy and the generalization ability of the second neural network. That is, the parameters of the second neural network are fine-tuned under the supervision of the classification result of the overlapped pixels which is output by the trained first neural network, thereby optimizing the image segmentation performance of the second neural network. For example, the parameters of the last two layers of the second neural network are updated according to the third classification result and the fourth classification result.

In some embodiments of the disclosure, the first image is the transverse image, and the second image is the coronal image or the sagittal image. Because the resolution of the transverse image is relatively high, using the transverse image to train the second neural network obtains more accurate segmentation results.

It is noted that although the first image and the second image are introduced as above by taking that the first image is the transverse image, and the second image is the coronal image or the sagittal image as an example, those skilled in the art can understand that the disclosure should not be limited to this, and those skilled in the art can choose the type of the first image and the type of the second image according to the actual application scenarios, as long as the scanning planes of the first image and the second image are different.

In some embodiments of the disclosure, the second neural network is the U-Net.

It can be seen that by adopting the U-Net as the structure of the second neural network, the second neural network makes use of the features of different scales of the image when extracting the features of the image, and fuses the features extracted from the second neural network at a relatively shallow layer with the features extracted from the second neural network at a relatively deep layer, so as to fully integrate and make use of multi-scale information.

In some embodiments of the disclosure, in the process of training the first neural network and/or the second neural network, an early stop strategy is adopted, that is, the training is stopped once the network performance is no longer improved, thus preventing over-fitting.

The embodiments of the disclosure also provide another method for neural network training. The method for neural network training comprises: determining a third classification result of overlapped pixels in a first image and a second image through a first neural network; determining a fourth classification result of pixels in the first image through the second neural network; and training the second neural network according to the third classification result and the fourth classification result.

In the above way, the second neural network is trained under the supervision of the classification result of the overlapped pixels which is output through the trained first neural network, which further improves the segmentation accuracy and the generalization ability of the second neural network.

In some embodiments of the disclosure, determining the third classification result of the overlapped pixels in the first image and the second image through the first neural network includes: extracting a first feature of the first image and a second feature of the second image; fusing the first feature and the second feature to obtain a third feature; and determining the third classification result of the overlapped pixels in the first image and the second image according to the third feature.

It can be seen that in the embodiments of the disclosure, two images are combined to segment the overlapped pixels in the two images, so as to improve the accuracy of image segmentation.

In some embodiments of the disclosure, the first neural network is trained according to the third classification result and labeled data corresponding to the overlapped pixels.

In this way, the first neural network obtained by training combines two images to segment the overlapped pixels in the two images, so as to improve the accuracy of image segmentation.

In some embodiments of the disclosure, a second classification result of the pixels in the first image is determined; and the second neural network is trained according to the second classification result and labeled data corresponding to the first image.

It can be seen that, in the embodiments of the disclosure, the second neural network is used to determine segmentation results of the image layer by layer, which overcomes the problem of low inter-layer resolution of the image and obtain more accurate segmentation results.

The embodiments of the disclosure also provide a method for image segmentation, which is executed by a device for image segmentation. The device for image segmentation is a UE, a mobile device, a user terminal, a terminal, a cell phone, a cordless phone, a PDA, a handheld device, a computing device, a vehicle device, a wearable device, or the like. In some embodiments of the disclosure, the method for image segmentation is implemented by a processor through calling a computer-readable instruction stored in the memory.

In the embodiments of the disclosure, the method for image segmentation includes: obtaining the trained second neural network according to the method for neural network training; and inputting a third image into the trained second neural network, and outputting a fifth classification result of pixels in the third image through the trained second neural network.

In the embodiments of the disclosure, the third image is a three-dimensional image, and the second neural network is used for determining the fifth classification result of each pixel of each two-dimensional slice of the third image layer by layer.

In the method for image segmentation provided by the embodiments of the disclosure, by inputting the third image into the trained second neural network and outputting the fifth classification result of the pixels in the third image through the trained second neural network, the image is automatically segmented, so that the time of image segmentation is saved, and the accuracy of image segmentation is improved.

The method for image segmentation provided by the embodiments of the disclosure is used to determine the boundary of the tumor prior to the limb salvage surgery, for example, to determine the boundary of the pelvic bone tumor prior to the limb salvage surgery. In the related art, experienced doctors are required to draw the boundary of bone tumor manually. In the embodiments of the disclosure, automatically determining the bone tumor region in the image can save the doctor's time, greatly reduce the time spent on bone tumor segmentation and improve the efficiency of preoperative surgical planning for limb salvage surgery.

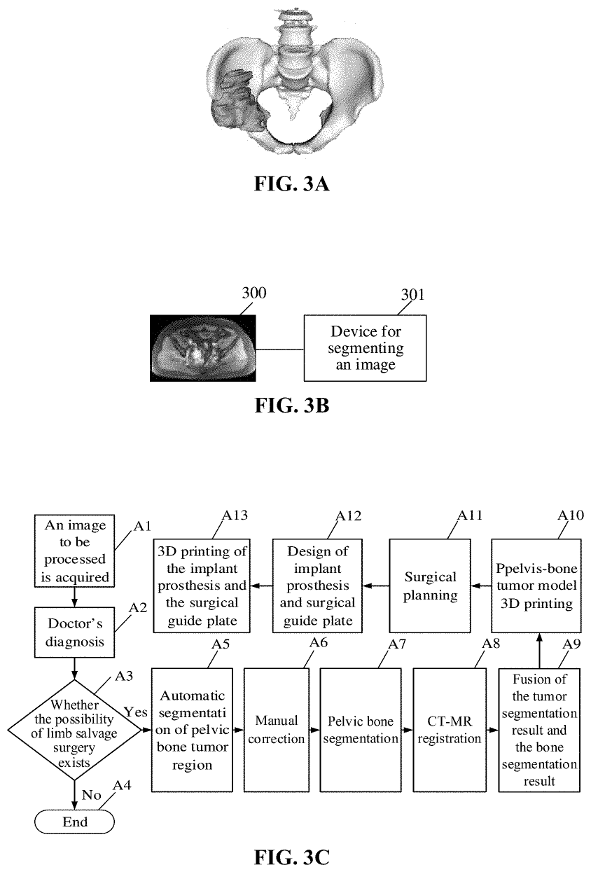

In some embodiments of the disclosure, the bone tumor region in the third image is determined according to the fifth classification result of the pixels in the third image which is output through the trained second neural network. FIG. 3A is a diagram of a pelvic bone tumor region in a method for image segmentation provided by an embodiment of the disclosure.

In some embodiments of the disclosure, the method for image segmentation further includes: performing bone segmentation on a fourth image corresponding to the third image to obtain a bone segmentation result corresponding to the fourth image. In the implementation mode, the third image and the fourth image are images obtained by scanning the same object.

It can be seen that in the embodiments of the disclosure, the bone boundary in the fourth image is determined according to the bone segmentation result corresponding to the fourth image.

In some embodiments of the disclosure, the method for image segmentation further includes: determining the correspondences between the pixels in the third image and pixels in the fourth image; and fusing the fifth classification result and the bone segmentation result to obtain a fusion result according to the correspondences.

It can be seen that by fusing the fifth classification result and the bone segmentation result according to the correspondences between the pixels in the third image and the pixels in the fourth image to obtain the fusion result, doctors is helped to learn the position of bone tumor in the pelvis during surgical planning and implant design.

In the embodiments of the disclosure, registration of the third image and the fourth image is performed through a related algorithm to determine the correspondences between the pixels in the third image and the pixels in the fourth image.

In some embodiments of the disclosure, the fifth classification result is overlaid on the bone segmentation result according to the correspondences to obtain the fusion result.

In some embodiments of the disclosure, before the fifth classification result and the bone segmentation result are fused, the doctors also manually corrects the fifth classification result to further improve the accuracy of bone tumor segmentation.

In some embodiments of the disclosure, the third image is a MRI image, and the fourth image is a CT image.

In the implementation mode, by using different types of images, information in the different types of images is fully combined, so as to better help doctors learn the position of bone tumor in the pelvis during surgical planning and implant design.

The application scenario of the disclosure is described in combination with the accompanying drawings below. FIG. 3B is a diagram of an application scenario in an embodiment of the disclosure. As shown in FIG. 3B, a MRI image 300 of a pelvic region is the third image above which is input into a device 301 for image segmentation to obtain the fifth classification result. In some embodiments of the disclosure, the fifth classification result includes the bone tumor region of the pelvis. It is to be noted that the scenario shown in FIG. 3B is only an exemplary scenario of the embodiments of the disclosure, and the disclosure does not limit the specific application scenario.

FIG. 3C is a diagram of a processing flow for pelvic bone tumor in the embodiments of the disclosure. As shown in FIG. 3C, the processing flow includes the following operations.

A1: obtaining the images to be processed.

Here, the image to be processed includes an MRI image and a CT image of a pelvic region of a patient. In the embodiments of the disclosure, the MRI image and the CT image of the pelvic region are obtained by MRI examination and CT examination.

A2: a doctor makes a diagnosis.

In the embodiments of the disclosure, the doctor makes a diagnosis based on the image to be processed, and then the block A3 is performed.

A3: determining whether the possibility of limb salvage surgery exists; if so, the block A5 is performed; or else, the block A4 is performed.

In the embodiments of the disclosure, the doctor determines, based on a diagnosis result, whether the possibility of limb salvage surgery exists.

A4: the flow ends.

In the embodiments of the disclosure, if the doctor determines that there is no possibility of limb salvage surgery, the flow ends. In this case, the doctor treats the patient in other ways.

A5: automatically segmenting a pelvic bone tumor region.

In the embodiments of the disclosure, by referring to FIG. 3B, the MRI image 300 of the pelvic region is input into the above device 301 for image segmentation, so as to realize the automatic segmentation of the pelvic bone tumor region and determine the pelvic bone tumor region.

A6: manual correction.

In the embodiments of the disclosure, the doctor manually corrects a segmentation result of the pelvic bone tumor region to obtain the corrected pelvic bone tumor region.

A7: segmenting the pelvic bone.

In the embodiments of the disclosure, the CT image of the pelvic region is the fourth image above. In this way, bone segmentation is performed on the CT image of the pelvic region to obtain a bone segmentation result corresponding to the CT image of the pelvic region.

A8: CT-MR (Computed Tomography-Magnetic Resonance) registration.

In the embodiments of the disclosure, the MRI image and the CT image of the pelvic region are registered to determine correspondences between the pixels in the MRI image and the pixels in the CT image of the pelvic region.

A9: fusing the tumor segmentation result and the bone segmentation result.

In the embodiments of the disclosure, and the segmentation result of the pelvic bone tumor region and the bone segmentation result corresponding to the CT image of the pelvic region are fused according to the correspondences determined in the block A8, to obtain a fusion result.

A10: printing the pelvis-bone tumor model in 3-Dimension (3D).

In the embodiments of the disclosure, the pelvis-bone tumor model is printed in 3D according to the fusion result.

A11: preoperative surgical planning.

In the embodiments of the disclosure, the doctor performs preoperative surgical planning based on the printed pelvis-bone tumor model.

A12: designing an implant prosthesis and a surgical guide plate.

In the embodiments of the disclosure, after preoperative surgical planning, the doctor designs the implant prosthesis and the surgical guide plate.

A13: implanting 3D printing of the implant prosthesis and the surgical guide plate.

In the embodiments of the disclosure, after designing the implant prosthesis and the surgical guide plate, the doctor performs 3D printing of the implant prosthesis and the surgical guide plate.

It can be understood that each method embodiment mentioned in the disclosure can be combined to form combined embodiments without departing from principles and logics. For saving the space, elaborations are omitted in the disclosure.

It can be understood by those skilled in the art that in the method of the specific implementation modes, the writing sequence of each operation does not mean a strict execution sequence and is not intended to form any limit to the implementation process and a specific execution sequence of each operation should be determined by functions and probable internal logic thereof.

In addition, the disclosure also provides a device for neural network training, a device, electronic device, computer-readable storage medium, and computer program for image segmentation, which are all used to implement any method for neural network training or method for image segmenting provided in the disclosure. The corresponding technical solution and description can refer to the corresponding records in the part of the methods, which will not be repeated.

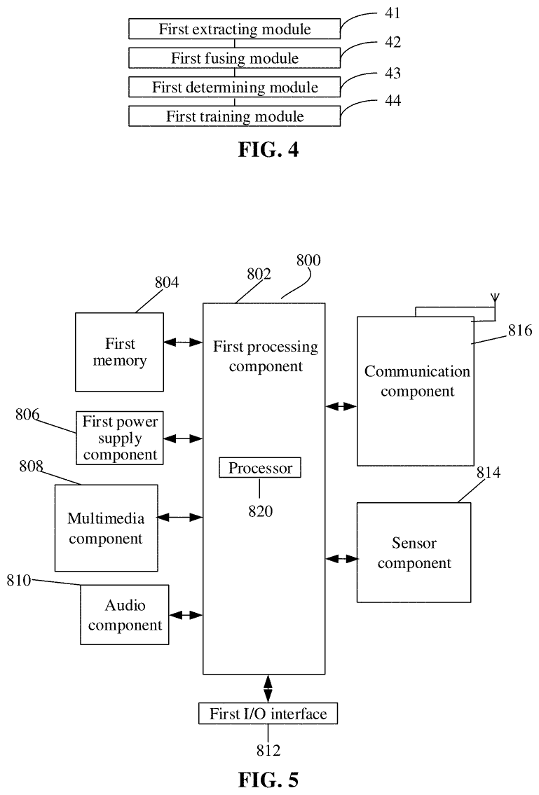

FIG. 4 is a structure diagram of a device for neural network training provided by an embodiment of the disclosure. As shown in FIG. 4, the device for neural network training includes: a first extracting module 41, configured to extract a first feature of a first image and a second feature of a second image through a first neural network; a first fusing module 42, configured to fuse the first feature and the second feature through the first neural network to obtain a third feature; a first determining module 43, configured to determine a first classification result of overlapped pixels in the first image and the second image through the first neural network according to the third feature; and a first training module 44, configured to train the first neural network according to the first classification result and labeled data corresponding to the overlapped pixels.

In some embodiments of the disclosure, the device further includes: a second determining module, configured to determine a second classification result of pixels in the first image through a second neural network; and a second training module, configured to train the second neural network according to the second classification result and labeled data corresponding to the first image.

In some embodiments of the disclosure, the device further includes: a third determining module, configured to determine a third classification result of the overlapped pixels in the first image and the second image through the trained first neural network; a fourth determining module, configured to determine a fourth classification result of the pixels in the first image through the trained second neural network; and a third training module, configured to train the second neural network according to the third classification result and the fourth classification result.

In some embodiments of the disclosure, the first image and the second image are scanned images, and a scanning plane of the first image is different from a scanning plane of the second image.

In some embodiments of the disclosure, the first image is a transverse image, and the second image is a coronal image or a sagittal image.

In some embodiments of the disclosure, each of the first image and the second image is an MRI image.

In some embodiments of the disclosure, the first neural network includes a first sub-network, a second sub-network and a third sub-network; the first sub-network is configured to extract the first feature of the first image, the second sub-network is configured to extract the second feature of the second image, and the third sub-network is configured to fuse the first feature and the second feature to obtain the third feature, and determine, according to the third feature, the first classification result of the overlapped pixels in the first image and the second image.

In some embodiments of the disclosure, the first sub-network is a U-Net without last two layers.

In some embodiments of the disclosure, the second sub-network is a U-Net without last two layers.

In some embodiments of the disclosure, the third sub-network is a multilayer perceptron.

In some embodiments of the disclosure, the second neural network is a U-Net.

In some embodiments of the disclosure, the classification result includes one or two of: a probability that the pixel belongs to the tumor region, or, a probability that the pixel belongs to the non-tumor region.

The embodiments of the disclosure also provide another device for neural network training, which includes: a sixth determining module, configured to determine a third classification result of overlapped pixels in a first image and a second image through a first neural network; a seventh determining module, configured to determine a fourth classification result of pixels in the first image through a second neural network; and a fourth training module, configured to train the second neural network according to the third classification result and the fourth classification result.

In some embodiments of the disclosure, determining the third classification result of the overlapped pixels in the first image and the second image through the first neural network, includes: a second extracting module, configured to extract a first feature of the first image and a second feature of the second image; a third fusing module, configured to fuse the first feature and the second feature to obtain a third feature; and an eighth determining module, configured to determine the third classification result of the overlapped pixels in the first image and the second image according to the third feature.

In some embodiments of the disclosure, another device for neural network training further includes: a fifth training module, configured to train the first neural network according to the third classification result and labeled data corresponding to the overlapped pixels.

In some embodiments of the disclosure, another device for neural network training further includes: a ninth determining module, configured to determine a second classification result of the pixels in the first image; and a sixth training module, configured to train the second neural network according to the second classification result and labeled data corresponding to the first image.

The embodiments of the disclosure also provide a device for image segmentation, which includes: an obtaining module, configured to obtain the trained second neural network according to the device for neural network training; and an outputting module, configured to input a third image into the trained second neural network, and output a fifth classification result of pixels in the third image through the trained second neural network.

In some embodiments of the disclosure, the device for image segmentation further includes: a bone segmentation module, configured to perform bone segmentation on a fourth image corresponding to the third image to obtain a bone segmentation result corresponding to the fourth image.

In some embodiments of the disclosure, the device for image segmentation further includes: a fifth determining module, configured to determine correspondences between the pixels in the third image and pixels in the fourth image; and a second fusing module, configured to fuse the fifth classification result and the bone segmentation result according to the correspondences to obtain a fusion result.

In some embodiments of the disclosure, the third image is an MRI image, and the fourth image is a CT image.

In some embodiments, functions of the device or modules contained in the device provided in the embodiments of the disclosure can be used to perform the method described in the above method embodiments, the specific implementation of which can refer to the description of the above method embodiments, and will not be described here for simplicity.

The embodiments of the disclosure also provide a computer-readable storage medium, having stored thereon a computer program instruction that, when executed by a processor, causes the processor to perform any aforementioned method. The computer-readable storage medium is a nonvolatile computer-readable storage medium or a volatile computer-readable storage medium.

The embodiments of the disclosure also provide a computer program product, which includes a computer-readable code that, when being run in a device, causes a processor in the device to execute an instruction for implementing any aforementioned method.

The embodiments of the disclosure also provide another computer program product, configured to store a computer readable instruction that, when executed, causes a computer to perform the operations of any aforementioned method.

The embodiments of the disclosure also provide an electronic device, which includes: one or more processors and a memory configured to store an executable instruction. The one or more processors are configured to call the executable instruction stored in the memory to execute any aforementioned method.

The electronic device is a terminal, a server or other forms of devices.

The embodiments of the disclosure also provide a computer program, which includes a computer-readable code that, when being run in an electronic device, causes a processor in the electronic device to perform any aforementioned method.

FIG. 5 is a structure diagram of an electronic device provided by an embodiment of the disclosure. For example, the electronic device 800 is a terminal such as a mobile phone, a computer, a digital broadcast terminal, a messaging device, a gaming console, a tablet, a medical device, exercise equipment, or a PDA.

Referring to FIG. 5, the electronic device 800 includes one or more of the following components: a first processing component 802, a first memory 804, a first power supply component 806, a multimedia component 808, an audio component 810, a first input/output (I/O) interface 812, a sensor component 814, and a communication component 816.

The first processing component 802 typically controls overall operations of the electronic device 800, such as the operations associated with display, telephone calls, data communications, camera operations, and recording operations. The first processing component 802 can include one or more processors 820 to execute instructions to perform all or part of the operations in the above method. Moreover, the first processing component 802 can include one or more modules which facilitate interaction between the first processing component 802 and the other components. For example, the first processing component 802 can include a multimedia module to facilitate interaction between the multimedia component 808 and the first processing component 802.

The first memory 804 is configured to store various types of data to support the operation of the electronic device 800. Examples of such data include instructions for any application programs or methods operated on the electronic device 800, contact data, phonebook data, messages, pictures, video, etc. The first memory 804 can be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The first power supply component 806 provides power for various components of the electronic device 800. The first power supply component 806 can include a power management system, one or more power supplies, and other components associated with generation, management and distribution of power for the electronic device 800.

The multimedia component 808 includes a screen providing an output interface between the electronic device 800 and a user. In some embodiments, the screen can include a Liquid Crystal Display (LCD) and a Touch Panel (TP). If the screen includes the TP, the screen can be implemented as a touch screen to receive an input signal from the user. The TP includes one or more touch sensors to sense touches, swipes and gestures on the TP. The touch sensors can not only sense a boundary of a touch or swipe action but also detect a duration and pressure associated with the touch or swipe action. In some embodiments, the multimedia component 808 includes a front camera and/or a rear camera. The front camera and/or the rear camera can receive external multimedia data when the electronic device 800 is in an operation mode, such as a photographing mode or a video mode. Each of the front camera and the rear camera can be a fixed optical lens system or have focal length and optical zooming capabilities.

The audio component 810 is configured to output and/or input an audio signal. For example, the audio component 810 includes a Microphone (MIC), and the MIC is configured to receive an external audio signal when the electronic device 800 is in the operation mode, such as a call mode, a recording mode and a voice recognition mode. The received audio signal can further be stored in the first memory 804 or sent through the communication component 816. In some embodiments, the audio component 810 further includes a speaker configured to output the audio signal.

The first I/O interface 812 provides an interface between the first processing component 802 and a peripheral interface module, and the peripheral interface module can be a keyboard, a click wheel, a button and/or the like. The button can include, but not limited to: a home button, a volume button, a starting button and a locking button.

The sensor component 814 includes one or more sensors configured to provide status assessment in various aspects for the electronic device 800. For example, the sensor component 814 can detect an on/off status of the electronic device 800 and relative positioning of components, such as a display and small keyboard of the electronic device 800, and the sensor component 814 can further detect a change in a position of the electronic device 800 or a component of the electronic device 800, presence or absence of contact between the user and the electronic device 800, the change in orientation or acceleration/deceleration of the electronic device 800 and the change in temperature of the electronic device 800. The sensor component 814 can include a proximity sensor configured to detect presence of an object nearby without any physical contact. The sensor component 814 can also include a light sensor, such as a Complementary Metal Oxide Semiconductor (CMOS) or Charge Coupled Device (CCD) image sensor, configured for use in an imaging application. In some embodiments, the sensor component 814 can also include an acceleration sensor, a gyroscope sensor, a magnetic sensor, a pressure sensor or a temperature sensor.

The communication component 816 is configured to facilitate wired or wireless communication between the electronic device 800 and another device. The electronic device 800 can access a communication-standard-based wireless network, such as a Wireless Fidelity (Wi-Fi) network, a 2nd-Generation (2G) network, a 3rd-Generation (3G) network, a 4th-Generation (4G)/Long Term Evolution (LTE) network, a 5th-Generation (5G) network or a combination thereof. In an exemplary embodiment, the communication component 816 receives a broadcast signal or broadcast associated information from an external broadcast management system through a broadcast channel. In an exemplary embodiment, the communication component 816 further includes a Near Field Communication (NFC) module to facilitate short-range communication. For example, the NFC module can be implemented based on a Radio Frequency Identification (RFID) technology, an Infrared Data Association (IrDA) technology, an Ultra-Wide Band (UWB) technology, a Bluetooth (BT) technology and other technologies.

In the exemplary embodiment, the electronic device 800 can be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute any of the abovementioned methods.

In the exemplary embodiment, a non-transitory computer-readable storage medium is also provided, for example, a first memory 804 including a computer program instruction. The computer program instruction can be executed by a processor 820 of the electronic device 800 to implement the abovementioned any method.

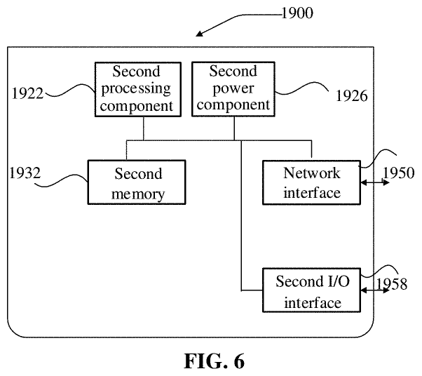

FIG. 6 is a structure diagram of another electronic device provided by an embodiment of the disclosure. For example, the electronic device 1900 can be provided as a server. Referring to FIG. 6, the electronic device 1900 includes a second processing component 1922, further including one or more processors, and a memory resource represented by a second memory 1932, configured to store an instruction executable by the second processing component 1922, for example, an Application. The application stored in the second memory 1932 can include one or more than one module of which each corresponds to a set of instructions. In addition, the second processing component 1922 is configured to execute the instruction to execute the abovementioned method.

The electronic device 1900 can further include a second power component 1926 configured to execute power management of the electronic device 1900, a wired or wireless network interface 1950 configured to connect the electronic device 1900 to a network, and the second I/O interface 1958. The electronic device 1900 can be operated based on an operating system stored in the second memory 1932, for example, Windows Server®, Max OS X®, Unix®, Linux®, FreeBSD® or the like.

In the exemplary embodiment, a non-transitory computer-readable storage medium is also provided, for example, a second memory 1932 including a computer program instruction. The computer program instruction can be executed by a second processing component 1922 of an electronic device 1900 to implement the abovementioned any method.

The embodiments of the disclosure can be a system, a method and/or a computer program product. The computer program product can include a computer-readable storage medium, in which a computer-readable program instruction configured to enable a processor to implement each aspect of the disclosure is stored.

The computer-readable storage medium can be a physical device capable of retaining and storing an instruction used by an instruction execution device. For example, the computer-readable storage medium can be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a RAM, a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here can be downloaded from the computer-readable storage medium to each computing/processing device or downloaded to an external computer or an external storage device through a network such as the Internet, a Local Area Network (LAN), a Wide Area Network (WAN) and/or a wireless network. The network can include a copper transmission cable, optical fiber transmission, wireless transmission, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the embodiments of the disclosure can be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction can be completely executed in a computer of a user or partially executed in the computer of the user, executed as an independent software package, executed partially in the computer of the user and partially in a remote computer, or executed completely in the remote server or a server. Under the condition that the remote computer is involved, the remote computer can be connected to the computer of the user through any type of network including an LAN or a WAN, or, can be connected to an external computer (for example, connected by an Internet service provider through the Internet). In some embodiments, an electronic circuit such as a programmable logic circuit, an FPGA or a Programmable Logic Array (PLA) can be customized by use of state information of a computer-readable program instruction, and the electronic circuit can execute the computer-readable program instruction, thereby implementing each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams can be implemented by computer-readable program instructions.

These computer-readable program instructions can be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions can also be stored in a computer-readable storage medium, and through these instructions, the computer, the programmable data processing device and/or another device can work in a specific manner, so that the computer-readable medium including the instructions includes a product including instructions for implementing each aspect of the function/action specified in one or more blocks in the flowcharts and/or the block diagrams.

These computer-readable program instructions can further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams can represent part of a module, a program segment or an instruction, and part of the module, the program segment or the instruction includes one or more executable instructions configured to realize a specified logical function. In some alternative implementations, the functions marked in the blocks can also be realized in a sequence different from those marked in the drawings. For example, two continuous blocks can actually be executed substantially concurrently and can also be executed in a reverse sequence sometimes, which is determined by the involved functions. It is further to be noted that each block in the block diagrams and/or the flowcharts and a combination of the blocks in the block diagrams and/or the flowcharts can be implemented by a dedicated hardware-based system configured to execute a specified function or operation or can be implemented by a combination of a special hardware and a computer instruction.

The computer program product can be specifically realized by means of hardware, software or a combination thereof. In an optional embodiment, the computer program product is specifically embodied as a computer storage medium, and in another optional embodiment, the computer program product is specifically embodied as software products, such as a Software Development Kit (SDK).

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or improvements in the technologies in the market best or enable others of ordinary skill in the art to understand each embodiment disclosed herein.

### INDUSTRIAL APPLICABILITY

The embodiments of the disclosure provide a method, device, electronic device, computer storage medium and computer program for neural network training and image segmentation. The method includes that: a first feature of a first image and a second feature of a second image are extracted through a first neural network; the first feature and the second feature are fused through the first neural network to obtain a third feature; a first classification result of overlapped pixels in the first image and the second image is determined through the first neural network according to the third feature; and the first neural network is trained according to the first classification result and labeled data corresponding to the overlapped pixels. In this way, the first neural network obtained through training combines two images to segment the overlapped pixels in the two images, so as to improve the accuracy of image segmentation.

1. A method for neural network training, comprising:
extracting, through a first neural network, a first feature of a first image and a second feature of a second image;
fusing, through the first neural network, the first feature and the second feature to obtain a third feature;
determining, through the first neural network, a first classification result of overlapped pixels in the first image and the second image according to the third feature; and
training the first neural network according to the first classification result and labeled data corresponding to the overlapped pixels.

2. The method of claim 1, further comprising:
determining, through a second neural network, a second classification result of pixels in the first image; and
training the second neural network according to the second classification result and labeled data corresponding to the first image.

3. The method of claim 2, further comprising:
determining, through the trained first neural network, a third classification result of the overlapped pixels in the first image and the second image;
determining, through the trained second neural network, a fourth classification result of the pixels in the first image; and
training the second neural network according to the third classification result and the fourth classification result.

4. The method of claim 1, wherein each of the first image and the second image is a scanned image, and a scanning plane of the first image is different from a scanning plane of the second image, and
wherein the first image is a transverse image, and the second image is a coronal image or a sagittal image.

5. The method of claim 1, wherein each of the first image and the second image is a Magnetic Resonance Imaging (MRI) image.

6. The method of claim 1, wherein the first neural network comprises a first sub-network, a second sub-network and a third sub-network; wherein the first sub-network is configured to extract the first feature of the first image, the second sub-network is configured to extract the second feature of the second image, and the third sub-network is configured to fuse the first feature and the second feature to obtain the third feature, and, determine according to the third feature, the first classification result of the overlapped pixels in the first image and the second image.

7. The method of claim 6, wherein at least one of the following applies:
the first sub-network is a U-Net without last two layers,
the second sub-network is a U-Net without last two layers, or
the third sub-network is a multilayer perceptron.

8. The method of claim 2, wherein the second neural network is a U-Net.

9. The method of claim 1, wherein the first classification result comprises one or two of: a probability that the pixel belongs to a tumor region, or, a probability that the pixel belongs to a non-tumor region.

10. A method for neural network training, comprising:
determining, through a first neural network, a third classification result of overlapped pixels in a first image and a second image;
determining, through a second neural network, a fourth classification result of pixels in the first image; and
training the second neural network according to the third classification result and the fourth classification result.

11. The method of claim 10, wherein determining, through the first neural network, the third classification result of the overlapped pixels in the first image and the second image comprises:
extracting a first feature of the first image and a second feature of the second image;
fusing the first feature and the second feature to obtain a third feature; and
determining the third classification result of the overlapped pixels in the first image and the second image according to the third feature.

12. The method of claim 10, further comprising:
training the first neural network according to the third classification result and labeled data corresponding to the overlapped pixels.

13. The method of claim 10, further comprising:
determining a second classification result of the pixels in the first image; and
training the second neural network according to the second classification result and labeled data corresponding to the first image.

14. A method for image segmentation, comprising:
obtaining the trained second neural network according to the method of claim 2; and
inputting a third image into the trained second neural network and outputting a fifth classification result of pixels in the third image through the trained second neural network.

15. The method of claim 14, further comprising:
performing bone segmentation on a fourth image corresponding to the third image to obtain a bone segmentation result corresponding to the fourth image.

16. The method of claim 15, further comprising:
determining correspondences between the pixels in the third image and pixels in the fourth image; and
according to the correspondences, fusing the fifth classification result and the bone segmentation result to obtain a fusion result.

17. The method of claim 15, wherein the third image is a Magnetic Resonance Imaging (MRI) image, and the fourth image is a Computed Tomography (CT) image.

18. An electronic device, comprising:
one or more processors;
a memory configured to store an executable instruction;
wherein the one or more processors are configured to call the executable instruction stored in the memory to perform the following operations comprising:
extracting a first feature of a first image and a second feature of a second image through a first neural network;
fusing the first feature and the second feature through the first neural network to obtain a third feature;
determining a first classification result of overlapped pixels in the first image and the second image through the first neural network according to the third feature; and
training the first neural network according to the first classification result and labeled data corresponding to the overlapped pixels.

19. The electronic device of claim 18, wherein the processor is further configured to:
determine a second classification result of pixels in the first image through a second neural network; and
train the second neural network according to the second classification result and labeled data corresponding to the first image.

20. A non-transitory computer-readable storage medium, having stored thereon a computer program instruction that, when executed by a processor of an electronic device, causes the processor to perform the method of claim 1.
